(19) United States
(12) Patent Application Publication
(10) Pub. No.: US 2020/0196065 A1
(43) Pub. Date: Jun. 18, 2020

(54) MICROPHONE ASSEMBLIES INCLUDING INTEGRATED VIBRATION TRANSDUCER AND WEARABLE DEVICES INCLUDING THE SAME

(71) Applicant: Knowles Electronics, LLC, Itasca, IL (US)

(72) Inventors: Michael Pedersen, Itasca, IL (US); John Albers, Itasca, IL (US); Daryl Barry, Itasca, IL (US); Venkataraman Chandrasekaran, Itasca, IL (US); Sarmad Qutub, Itasca, IL (US); Joshua Watson, Itasca, IL (US)

(73) Assignee: Knowles Electronics, LLC, Itasca, IL (US)

(21) Appl. No.: 16/711,386

(22) Filed: Dec. 11, 2019

Related U.S. Application Data
(60) Provisional application No. 62/778,741, filed on Dec. 12, 2018.

(51) Int. Cl. H04R 19/04; H04R 7/04; H04R 7/16

(52) U.S. Cl. CPC H04R 19/04; H04R 2201/003; H04R 7/16; H04R 7/04

(57) ABSTRACT

A transducer assembly comprises an acoustic transducer comprising a transducer substrate having a first aperture defined at a first location of the transducer substrate, an acoustic transducer diaphragm disposed on the transducer substrate over the first aperture, and an acoustic transducer back plate disposed on the transducer substrate axially spaced apart from the acoustic transducer diaphragm over the first aperture. The transducer assembly also includes a vibration transducer comprising the transducer substrate having a second aperture defined at a second location thereof, a vibration transducer diaphragm disposed on the transducer substrate over the second aperture, a vibration transducer back plate disposed on the transducer substrate axially spaced apart from the vibration transducer back plate over the second aperture, and an anchor coupled to one of the vibration transducer diaphragm or the vibration transducer back plate, the anchor disposed in the second aperture and suspended freely therewithin.

### CROSS-REFERENCE TO RELATED APPLICATIONS

The present application claims priority to and benefit of U.S. Provisional Application No. 62/778,741, filed Dec. 12, 2018, the entire disclosure of which is hereby incorporated by reference herein.

### TECHNICAL FIELD

The present disclosure relates generally to MEMS transducer assemblies including a vibration transducer integrated with an acoustic transducer, and methods of operating wearables including such transducer assemblies.

### BACKGROUND

Microphone assemblies are used in electronic devices to convert acoustic energy to electrical signals. Advancements in micro and nanofabrication technologies have led to the development of progressively smaller micro-electro-mechanical-system (MEMS) microphone assemblies. Some microphone assemblies may be included in wearable devices. A common problem in wearable including such microphone assemblies is false awake from keywords based on acoustic signals, which may not be associated with an authorized user. Furthermore, such wearables have small energy storage devices with a limited power supply. Continuous power draw from such energy storage devices leads to short operating life of the wearables before the energy storage device thereof has to be recharged.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a top plan view of a transducer assembly including a vibration transducer integrated with an acoustic transducer, according to an embodiment.

FIG. 2 is a side cross-section view of the transducer assembly of FIG. 1, according to an embodiment.

FIG. 3 is a side cross-section view of a transducer assembly, according to another embodiment.

FIG. 4 is a side cross-section view of a transducer assembly, according to still another embodiment.

FIG. 5 is a side cross-section view of a transducer assembly, according to yet another embodiment.

FIG. 6 is a side cross-section view of a transducer assembly, according to further another embodiment.

FIG. 7 is a schematic flow diagram of a method for forming a transducer assembly including a vibration transducer integrated with an acoustic transducer, according to an embodiment.

FIG. 8 is a schematic illustration of a microphone assembly including the transducer assembly of FIG. 2, according to an embodiment.

FIG. 9 is a schematic block diagram of an integrated circuit included in the microphone assembly of FIG. 8, according to an embodiment.

FIG. 10A shows a plot of a correlated acoustic signal and a vibration signal detected by the transducer assembly of FIG. 8.

FIG. 10B is a plots of a correlated acoustic signal and a vibration signal after a fast Fourier transform (FFT).

FIG. 11 is a schematic flow diagram of a method for determining a correlation between an acoustic signal and a vibration signal generated by a user associated with a wearable device to determine if the user is an authorized user, according to an embodiment.

FIG. 12 is a schematic flow diagram of a method of selectively activating portions of a wearable device responsive to vibration signals and acoustic signals, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to transducer assemblies including a MEMS acoustic transducer and vibration transducer integrated into the same die. Embodiments described herein also relate to methods of correlating acoustic signal detected by the acoustic transducer with a vibration signal detected by the vibration transducer to determine whether the acoustic signal belongs to an authorized user, and activate portions of electronic circuitry of a wearable device including such transducer assemblies once a correlation is detected.

Small MEMS microphone assemblies have allowed incorporation of such microphone assemblies into compact devices such as cell phones, laptops, wearables, TV/set-top box remotes, etc. Incorporation of MEMS microphone assemblies is particularly suitable for wearable devices such as smart watches, wireless headphones, smart textiles, etc. The compact size of wearable devices places a restriction on size of an energy storage device (e.g., battery) included in the wearable device, therefore limiting the amount of electric power available on the onboard energy storage device included in the wearable device. Therefore, it is beneficial to conserve power by keeping at least some components of the wearable device, for example, portions of electronic circuits included in the wearable device such as an analog to digital converter (ADC) and/or a digital signal processor (DSP) powered off when not in use.

Moreover, users of wearable devices desire that the wearable devices respond to keywords or phrase. Keeping all circuits of the microphone assembly included in the wearable device always activated or ON to listen to the key words or phrase is not preferable as it increases power draw on the energy storage device included in the wearable device. In some wearable devices such as watches, to conserve power, the ADC, the DSP or other portions of the electrical circuit of the wearable device are only activated or turned ON when a user performs a specific gesture, for example, a wrist raise (e.g., detected by a separate accelerometer included in the wearable device) or when a button is pressed. This often leads to truncated key words as the user may start speaking before performing the gesture. Furthermore, to prevent false triggers such as those caused by other people present near the user speaking the same keywords, the user may have to go through an enrollment session to register the user's acoustic signature (e.g., voice pattern) with the wearable device. The microphone's sensitivity may also have to be adjusted to prevent false triggers, which may increase the probability of missing an actual keyword provided by an authorized user.

In contrast, embodiments of the transducer assemblies described herein, and methods of operating wearable devices including such transducer assemblies may provide one or more benefits including, for example: (1) integrating a vibration transducer (e.g., a single axis accelerometer) with an acoustic transducer on a single die allowing for monolithic sensing of acoustic and vibration signals; (2) providing a replacement for existing acoustic transducers; (3) enabling detection of vibration corresponding to an authorized user speaking, and allowing correlation with the acoustic signal generated by the authorized user wearing the wearable device; (4) saving power of an onboard energy storage device of the wearable device by selectively activating an ADC and DSP of a microphone assembly, or other components of the wearable device only when a correlation is determined between an acoustic signal detected by the acoustic transducer and a vibration signal detected by the vibration transducer; (5) eliminating use of gestures for initiating key word detection; and (6) reducing false triggers and eliminating enrollment sessions.

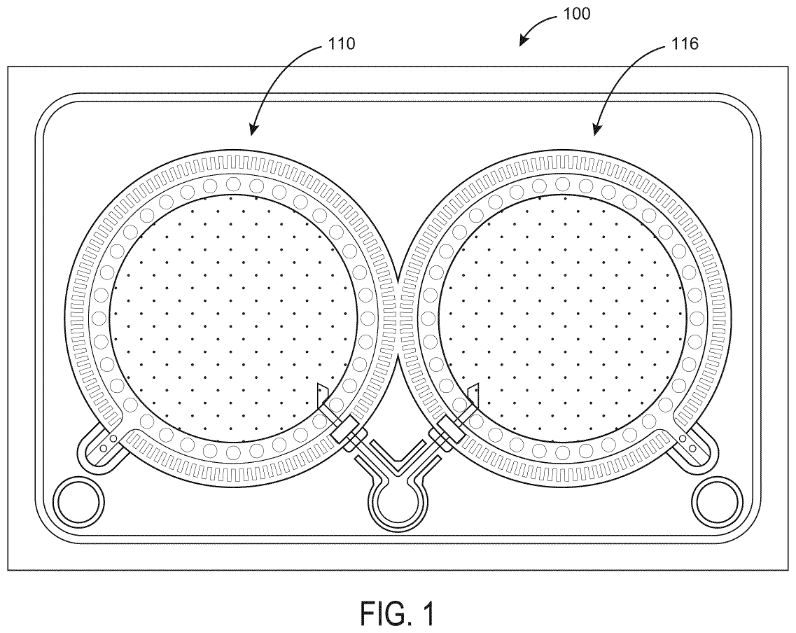

FIG. 1 is a top plan view of a transducer assembly 100, according to an embodiment. The transducer assembly 100 may be used in a microphone assembly included in a wearable device. The transducer assembly 100 includes an acoustic transducer 110 and a vibration transducer 160 monolithically formed with the acoustic transducer 110.

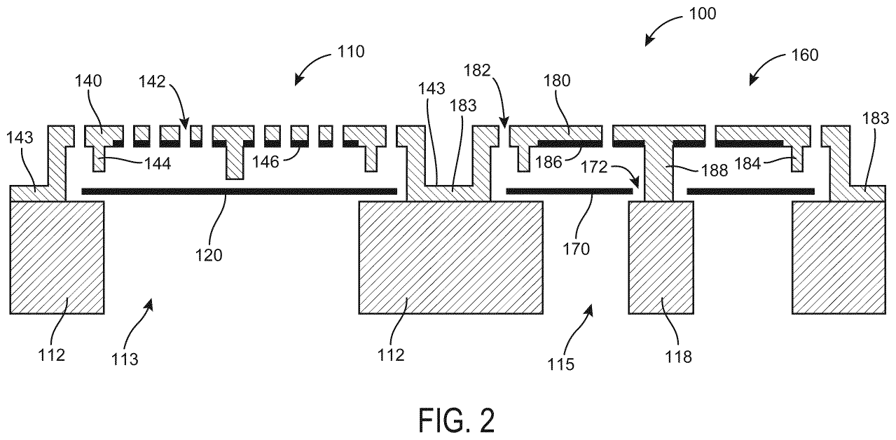

FIG. 2 is a side cross-section view of the transducer assembly 100 of FIG. 1, according to a particular embodiment. As shown in FIG. 2, the acoustic transducer 110 includes a transducer substrate 112 defining a first aperture 113 therein at a first location corresponding to the acoustic transducer 110. The transducer substrate 112 may be formed from silicon, glass, ceramics, or any other suitable material. In some embodiments, the first aperture 113 may define a circular cross-section.

An acoustic transducer diaphragm 120 is disposed on the transducer substrate 112 over the first aperture 113 about a longitudinal axis of the acoustic transducer 110, and is configured to vibrate in response to an acoustic signal received through the first aperture 113. The acoustic transducer diaphragm 120 may be formed from a conductive material or a sandwiched layer of conductive and capacitive materials. Materials used for forming the acoustic transducer diaphragm 120 may include, for example, silicon, silicon oxide, silicon nitride, silicon carbide, gold, aluminum, platinum, etc.

In other embodiments, at least a portion of the acoustic transducer diaphragm 120 may be formed using a piezoelectric material, for example, quartz, lead titanate, III-V and II-VI semi-conductors (e.g., gallium nitride, indium nitride, aluminum nitride, zinc oxide, etc.), graphene, ultra nanocrystalline diamond, polymers (e.g., polyvinylidene fluoride) or any other suitable piezoelectric material. For example, the piezoelectric material may be deposited as a ring around the acoustic transducer diaphragm 120 perimeter on top of the base material forming the acoustic transducer diaphragm 120 (e.g., silicon nitride or polysilicon). In such embodiments, vibration of the acoustic transducer diaphragm 120 responsive to the acoustic signal may generate an electrical signal (e.g., a piezoelectric current or voltage) which is representative of the acoustic signal.

An acoustic transducer back plate 140 is also disposed on the transducer substrate 112 axially spaced apart from the acoustic transducer diaphragm 120 over the first aperture 113. The acoustic transducer back plate 140 may be formed from polysilicon, silicon nitride, other suitable materials (e.g., silicon oxide, silicon, ceramics, etc.), or sandwiches thereof. Vibrations of the acoustic transducer diaphragm 120 relative to the acoustic transducer back plate 140 which is substantially fixed (e.g., substantially inflexible relative to the acoustic transducer diaphragm 120) in response to acoustic signals received on the acoustic transducer diaphragm 120 cause changes in the capacitance between the acoustic transducer diaphragm 120 and the acoustic transducer back plate 140, and corresponding changes in the generated electrical signal. A plurality of apertures 142 are defined in the acoustic transducer back plate 140, and a conductive or insulative layer 146 is disposed on a surface of the acoustic transducer back plate 140 proximate to the acoustic transducer diaphragm 120. Edges of the acoustic transducer back plate 140 are anchored on the transducer substrate 112 at an edge anchor 143 circumferentially positioned on the transducer substrate 112 around the first aperture 113. A plurality of protrusions or pillars 144 extending from the acoustic transducer back plate 140 towards the diaphragm 120 may serve as motion stops to limit displacement of the acoustic transducer diaphragm 120 relative to the acoustic transducer back plate 140, for example, to prevent collapse of the acoustic transducer diaphragm 120.

The transducer assembly 100 also comprises a vibration transducer 160 monolithically integrated with the acoustic transducer 110. The vibration transducer 160 includes a single axis accelerometer configured to sense vibrations or acceleration. The vibration transducer 160 includes the transducer substrate 112 having a second aperture 115 defined at a second location of the transducer substrate 112 radially spaced apart from first aperture 113. A vibration transducer diaphragm 170 is disposed on the transducer substrate 112 over the second aperture 115 and configured to vibrate in response to acceleration or vibration. For example, the transducer assembly 100 may be included in a wearable device and the vibration transducer diaphragm 170 or vibration transducer back plate 180 is configured to vibrate in response to body conduction vibration (e.g., bone conduction vibration) corresponding to speech of a user wearing the wearable device. The vibration transducer diaphragm 170 is formed from the same layer used to form the acoustic transducer diaphragm 120, and formed simultaneously therewith via the same fabrication operations.

A vibration transducer back plate 180 is disposed on the transducer substrate 112 axially spaced apart from the vibration transducer diaphragm 170 over the second aperture 115. The vibration transducer back plate 180 is formed from the same layer used to form the acoustic transducer back plate 140, and formed simultaneously therewith via the same fabrication operations. A plurality of apertures 182 are defined in the vibration transducer back plate 180, and a conductive or insulative layer 186 is disposed on a surface of the vibration transducer back plate 180 proximate to the vibration transducer diaphragm 170. Edges of the vibration transducer back plate 180 are anchored on the transducer substrate 112 at an edge anchor 183 circumferentially positioned on the transducer substrate 112 around the second aperture 115. A portion of the edge anchor 183 of the vibration transducer back plate 180 may be coupled with a portion of the edge anchor 143 of the acoustic transducer back plate 140. A plurality of protrusions or pillars 184 extend from the vibration transducer back plate 180 towards the vibration transducer diaphragm 170, for example, to limit displacement of the vibration transducer diaphragm 170.

The vibration transducer 160 also includes an anchor 118 coupled to the vibration transducer back plate 180 via a connecting structure 188. In some embodiments, the anchor 118 is attached to the vibration transducer diaphragm 170. The connecting structure 188 extends from the vibration transducer back plate 180 to the anchor 118 through an opening 172 defined in the vibration transducer diaphragm 170. In some embodiments, the connecting structure 188 includes a portion of a sacrificial layer, which is disposed between the transducer substrate 112 and the vibration transducer back plate 180 that is left unetched during the fabrication process. Furthermore, the anchor 118 includes an island of the transducer substrate 112 that is disposed in the second aperture 115, for example, formed by selective etching of the transducer substrate 112 at the second location. The anchor 118 is suspended freely within the second aperture 115 and serves as a suspended proof-mass.

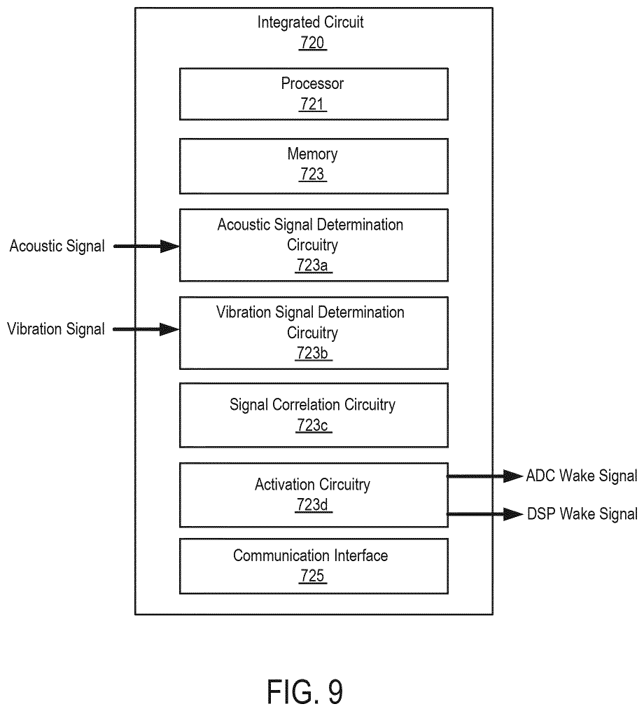

During operation, the acoustic transducer 110 responds to the acoustic signals, for example, acoustic signals generated by a user. Furthermore, the vibration transducer back plate 180 deflects or vibrates with respect to the vibration transducer diaphragm 170. For example, the vibration may include body conduction vibration corresponding to the acoustic signals due to the user speaking, and may be correlated with the acoustic signal, for example, to activate portions of an electronic circuitry included in a microphone assembly (e.g., the microphone assembly 10 shown in FIG. 9) and/or a wearable device (e.g., the wearable device 1 shown in FIG. 9), as described in further detail herein.

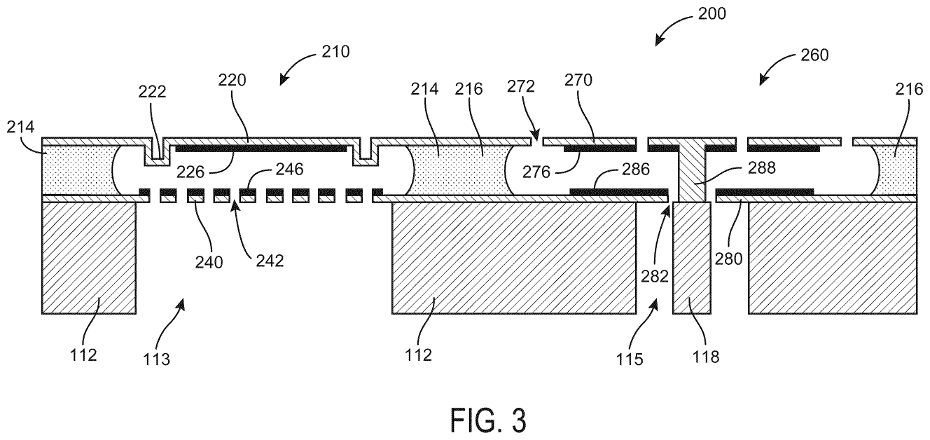

FIG. 3 is a side cross-section view of a transducer assembly 200, according to another embodiment. The transducer assembly 200 includes an acoustic transducer 210 and a vibration transducer 260 monolithically integrated with the acoustic transducer 210. As shown in FIG. 3, the transducer 210 includes the transducer substrate 112 defining a first aperture 113 therein at a first location corresponding to the acoustic transducer 210. An acoustic transducer back plate 240 is disposed on the transducer substrate 112 over the first aperture 113 about a longitudinal axis of the acoustic transducer 210. A plurality of apertures 242 are defined in the acoustic transducer back plate 240, and a conductive or insulative layer 246 is disposed on a surface of the acoustic transducer back plate 240 distal from the transducer substrate 112.

An acoustic transducer diaphragm 220 is disposed on the transducer substrate 112 over the first aperture 113 above the acoustic transducer back plate 240, and configured to vibrate in response to an acoustic signal received through the first aperture 113. A conductive or insulative layer 226 is disposed on the acoustic transducer diaphragm 220 proximate to the transducer substrate 112. At least one inward facing corrugation 222 extends from the acoustic transducer diaphragm 220 towards the acoustic transducer back plate 240. The inward facing corrugation 222 includes a circumferential corrugation formed in the acoustic transducer diaphragm 220 about the longitudinal axis of the acoustic transducer. In other embodiments, the acoustic transducer diaphragm 220 may include an outward facing corrugation extending from the acoustic transducer diaphragm 220 away from the transducer substrate 112.

A first peripheral support structure 214 is disposed between the acoustic transducer diaphragm 220 and the acoustic transducer back plate 240. The first peripheral support structure 214 comprises a circumferential structure that is attached to and supports at least a portion of a periphery of the acoustic transducer diaphragm 220 and is located proximate to an edge thereof. The peripheral support structure 214 is configured to reduce a stress on the acoustic transducer diaphragm 220. Various embodiments of acoustic transducers that can be included in the transducer assembly 200 of FIG. 3, and methods of fabrication thereof are described in U.S. Provisional Application No. 62/742,164, the entire disclosure of which is hereby incorporated herein by reference.

The transducer assembly 200 also comprises a vibration transducer 260 monolithically integrated with the acoustic transducer 210. The vibration transducer 260 includes a single axis accelerometer configured to sense vibrations or acceleration. The vibration transducer 260 includes the transducer substrate 112 having a second aperture 115 defined at a second location of the transducer substrate 112 radially spaced apart from first aperture 113. A vibration transducer back plate 280 is disposed on the transducer substrate 112 over the second aperture 115. The vibration transducer back plate 280 is formed from the same layer used to form the acoustic transducer back plate 240, and formed simultaneously therewith via the same fabrication operations. A plurality of apertures 282 are defined in the vibration transducer back plate 280, and a conductive or insulative layer 286 is disposed on a surface of the vibration transducer back plate 280 distal from the transducer substrate 112.

A vibration transducer diaphragm 270 is disposed on the transducer substrate 112 over the second aperture 115 above the vibration transducer back plate 280 and spaced apart therefrom. The vibration transducer diaphragm 270 is configured to vibrate in response to acceleration or vibration. For example, the transducer assembly 200 may be included in a wearable device and the vibration transducer diaphragm 270 or the vibration transducer back plate 280 is configured to vibrate in response to body conduction vibration (e.g., bone conduction vibration) corresponding to speech of a user wearing the wearable device. The vibration transducer diaphragm 270 is formed from the same layer used to form the acoustic transducer diaphragm 220, and formed simultaneously therewith via the same fabrication operations. A conductive or insulated layer 276 is disposed on a surface of the vibration transducer diaphragm 270 proximate to the transducer substrate 112.

A second peripheral support structure 216 is disposed between the acoustic transducer diaphragm 220 and the acoustic transducer back plate 240. Similar to the first peripheral support structure 214, the second peripheral support structure 216 also comprises a circumferential structure that is attached to and supports at least a portion of a periphery of the vibration transducer diaphragm 270 and is located proximate to an edge thereof. A portion of a radial edge of the second peripheral support structure 216 is coupled to a portion of a radial edge of the first peripheral support structure 214. For example, the first and second peripheral support structures may be monolithically formed in the same layer (e.g., a sacrificial layer), and formed simultaneously therewith via the same fabrication operations.

The vibration transducer 260 also includes the anchor 118 coupled to the vibration transducer diaphragm 270 via a connecting structure 288. In some embodiments, the anchor 118 may be attached to the vibration transducer back plate 280. The connecting structure 288 extends from the vibration transducer diaphragm 270 to the anchor 118 through a corresponding aperture 282 defined in the vibration transducer back plate 280. The anchor 118 serves as a suspended proof-mass, as previously described herein with respect to the vibration transducer 160.

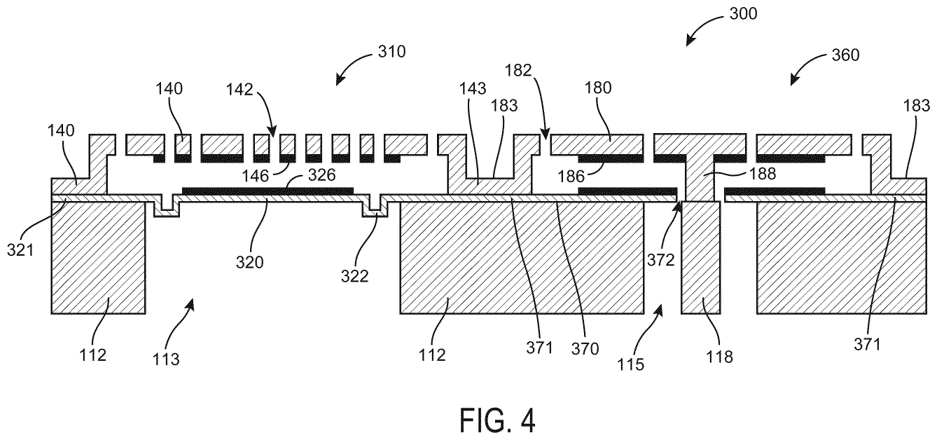

FIG. 4 is a side cross-section view of a transducer assembly 300, according to an embodiment. The transducer assembly 300 is similar to the transducer assembly 100 but has the following differences. The transducer assembly 300 includes an acoustic transducer 310 and a vibration transducer 360. The acoustic transducer 310 includes the transducer substrate 112 defining the first aperture 113 therein at a first location corresponding to the acoustic transducer 310. An acoustic transducer diaphragm 320 is disposed on the transducer substrate 112 over the first aperture 113 about a longitudinal axis of the acoustic transducer 310, and configured to vibrate in response to an acoustic signal received through the first aperture 113. Different from the acoustic transducer diaphragm 120, the acoustic transducer diaphragm 320 includes a circumferential outward facing corrugation 322 protruding from the acoustic transducer diaphragm 320 towards the transducer substrate 112.

The acoustic transducer back plate 140 is also disposed on the transducer substrate 112 axially spaced apart from the acoustic transducer diaphragm 320 over the first aperture 113. Edges of the acoustic transducer back plate 140 extend towards the transducer substrate 112 at an edge anchor 143 that is disposed over a peripheral edge 321 of the acoustic transducer diaphragm 320 that is disposed on the transducer substrate 112. Various embodiments of acoustic transducers, which may be included in the transducer assembly 300 of FIG. 4, are described in U.S. Provisional Application No. 62/743,149, the entire disclosure of which is hereby incorporated herein by reference.

The transducer assembly 300 also comprises a vibration transducer 360 monolithically integrated with the acoustic transducer 310. The vibration transducer 360 includes the transducer substrate 112 having the second aperture 115 defined at a second location of the transducer substrate 112 radially spaced apart from first aperture 113. A vibration transducer diaphragm 370 is disposed on the transducer substrate 112, and the vibration transducer back plate 180 is disposed above the vibration transducer diaphragm 370 over the second aperture 115. A peripheral edge 371 of the vibration transducer diaphragm 370 is disposed between the edge anchor 183 of the vibration transducer back plate 180 and the transducer substrate 112. The vibration transducer diaphragm 370 is formed from the same layer used to form the acoustic transducer diaphragm 220, and formed simultaneously therewith via the same fabrication operations. A portion of the peripheral edge 371 of the vibration transducer diaphragm 370 is coupled to a portion of the peripheral edge 321 of the acoustic transducer diaphragm 320. The vibration transducer 360 also includes the anchor 118 coupled to the vibration transducer back plate 180 via the connecting structure 188, that extends from the vibration transducer back plate 180 to the anchor 118 through an opening 372 defined in the vibration transducer diaphragm 370. In some embodiments, the anchor 118 is coupled to the vibration transducer diaphragm 370.

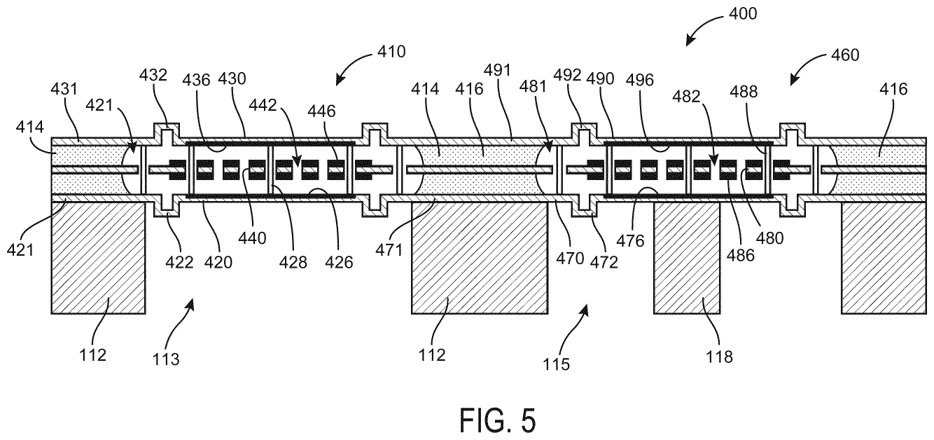

FIG. 5 is a side cross-section view of a transducer assembly 400, according to another embodiment. The transducer assembly 400 includes an acoustic transducer 410 and a vibration transducer 460. The acoustic transducer 410 includes the transducer substrate 112 defining the first aperture 113 therein at a first location corresponding to the acoustic transducer 410. An acoustic transducer bottom or first diaphragm 420 is disposed on the transducer substrate 112 over the first aperture 113 about a longitudinal axis of the acoustic transducer 410, and configured to vibrate in response to an acoustic signal received through the first aperture 113. The acoustic transducer first diaphragm 420 includes a circumferential first outward facing corrugation 422 protruding from the acoustic transducer first diaphragm 420 towards the transducer substrate 112. A conductive or insulative layer 426 is disposed on a surface of the acoustic transducer first diaphragm 420 distal from the transducer substrate 112.

An acoustic transducer top or second diaphragm 430 is disposed over the acoustic transducer first diaphragm 420 and spaced apart therefrom such that a first cavity 421 is defined therebetween. The first cavity 421 is at a pressure, which is lower than atmospheric pressure, for example, in a range of 1 mTorr to 1 Torr. The acoustic transducer second diaphragm 430 includes a circumferential second outward facing corrugation 432 protruding outwards from the acoustic transducer second diaphragm 430 away from the transducer substrate 112. A conductive or insulative layer 436 is disposed on a surface of the acoustic transducer second diaphragm 430 proximate to the transducer substrate 112.

The acoustic transducer back plate 440 is disposed in the first cavity 421 between the acoustic transducer first and second diaphragms 420 and 430. A plurality of apertures 442 are defined through the acoustic transducer back plate 440 such that a portion of the first cavity 421 located between the acoustic transducer first diaphragm 420 and the acoustic transducer back plate 440 is connected to another portion of the first cavity 421 located between the acoustic transducer back plate 440 and the acoustic transducer second diaphragm 430. A conductive or insulative layer 446 may be disposed on one or both surface of the acoustic transducer back plate 440.

A plurality of acoustic transducer posts 428 extend from the acoustic transducer second diaphragm 430 towards the acoustic transducer first diaphragm 420 through corresponding apertures 442 defined in the acoustic transducer back plate 440. In some embodiments, one or more of the acoustic transducer posts 428 may include an unanchored post which extend from the acoustic transducer first or second diaphragm 420 or 430 to the opposite acoustic transducer first or second diaphragm 420 or 430 such that a gap or space exists between a tip of the acoustic transducer post 428 and the respective acoustic transducer diaphragms 420 or 430 proximate to a tip of the acoustic transducer post 428. Contact of the tip with the respective acoustic transducer diaphragm 420 or 430 is only made when a sufficiently high force or pressure acts on one or both the acoustic transducer diaphragms 420 or 430 (e.g., ambient pressure or electrostatic force due to bias) such that the unanchored posts can both slide and rotate relative to the respective acoustic transducer diaphragm 420 or 430.

In other embodiments, one or more of the acoustic transducer posts 428 may include a non-rigidly connected post 428 which extend from the acoustic transducer first or second diaphragm 420 or 430 to the opposite acoustic transducer diaphragm 420 or 430 such that a tip of the acoustic transducer post 428 is in permanent contact with the opposing acoustic transducer diaphragm 420 or 430 so as to allow bending or rotation of the acoustic transducer post 428 near or proximate to the point of contact. In still other embodiments, one or more of the acoustic transducer posts 428 includes an anchored post including a tip that is in contact with the opposing acoustic transducer first or second diaphragm 420 or 430 such that the anchored post 428 is immovable relative to the opposing acoustic transducer diaphragm 420 or 430.

A first peripheral support structure 414 is disposed in the first cavity 421 proximate to perimetral edges 421 and 431 of the acoustic transducer first and second diaphragms 420 and 430 over the acoustic transducer first diaphragm 420. The periphery of the acoustic transducer back plate 440 is embedded in the peripheral support structure 414. Various embodiments of acoustic transducers, which may be included in the transducer assembly 400 of FIG. 5, are described in U.S. Provisional Application No. 62/742,153, the entire disclosure of which is hereby incorporated herein by reference.

The transducer assembly 400 also comprises a vibration transducer 460 monolithically integrated with the acoustic transducer 410. The vibration transducer 460 includes a single axis accelerometer configured to sense vibrations or acceleration. The vibration transducer 460 includes the transducer substrate 112 having a second aperture 115 defined at a second location of the transducer substrate 112 radially spaced apart from first aperture 113. A vibration transducer first diaphragm 470 is disposed on the transducer substrate 112 over the second aperture 115 and configured to vibrate in response to acceleration or vibration. The vibration transducer first diaphragm 470 also includes a circumferential first outward facing corrugation 472 protruding outwards from the vibration transducer first diaphragm 470 towards the transducer substrate 112. A conducting or insulative layer 476 is disposed on a surface of the vibration transducer first diaphragm 470 distal from the transducer substrate 112. The vibration transducer first diaphragm 470 is formed from the same layer used to form the acoustic transducer first diaphragm 420, and formed simultaneously therewith via the same fabrication operations.

A vibration transducer second diaphragm 490 is disposed over the vibration transducer first diaphragm 470 and spaced apart therefrom such that a second cavity 481 is formed therebetween. The second cavity 481 is also at a pressure lower than atmospheric pressure, for example, in a range between 0.1 mTorr to 1 Torr. A circumferential second outward facing corrugation 492 protrudes outwards from the vibration transducer second diaphragm away from the transducer substrate 112. A conductive or insulative layer 496 is disposed on a surface of the acoustic transducer second diaphragm 490 proximate to the transducer substrate 112. The vibration transducer second diaphragm 490 is formed from the same layer used to form the acoustic transducer second diaphragm 430, and formed simultaneously therewith via the same fabrication operations.

A vibration transducer back plate 480 is disposed in the second cavity 481 between the vibration transducer first and second diaphragms 470 and 480. A plurality of apertures 482 are defined through the vibration transducer back plate 480 such that a portion of the second cavity 481 located between the vibration transducer first diaphragm 470 and the vibration transducer back plate 480 is connected with another portion of the second cavity 481 located between the vibration transducer back plate 480 and the vibration transducer second diaphragm 490. A conducting layer 486 is disposed on one or more surfaces of the vibration transducer back plate 480. The vibration transducer back plate 480 is formed from the same layer used to form the acoustic transducer back plate 240, and formed simultaneously therewith via the same fabrication operations.

A second peripheral support structure 416 is disposed in the second cavity 481 proximate perimetral edges 471 and 491 of the vibration transducer first and second diaphragms 470 and 490 over the vibration transducer first diaphragm 470. The periphery of the vibration transducer back plate 480 is embedded in the second peripheral support structure 416. A portion of a radial edge of the second peripheral support structure 416 is coupled to a corresponding portion of a radial edge of the first peripheral support structure 414. For example, the first and second peripheral support structures 414 and 416 may be monolithically formed in the same layer (e.g., a sacrificial layer), and formed simultaneously via the same fabrication operations.

A plurality of vibration transducer posts 488 extend from the vibration transducer second diaphragm 490 towards the vibration transducer first diaphragm 470 through corresponding apertures 482 defined in the vibration transducer back plate 480. One or more of the vibration transducer posts 488 may include unanchored posts, non-rigidly connected posts or rigidly connected posts, as previously described herein.

The vibration transducer 460 also includes the anchor 118 coupled to the vibration transducer first diaphragm 470. The anchor 118 is suspended freely within the second aperture 115 and serves as a suspended proof-mass. The vibration transducer first diaphragm 470 is configured to vibrate in response to vibrations or acceleration and generate a signal corresponding to the vibration or acceleration.

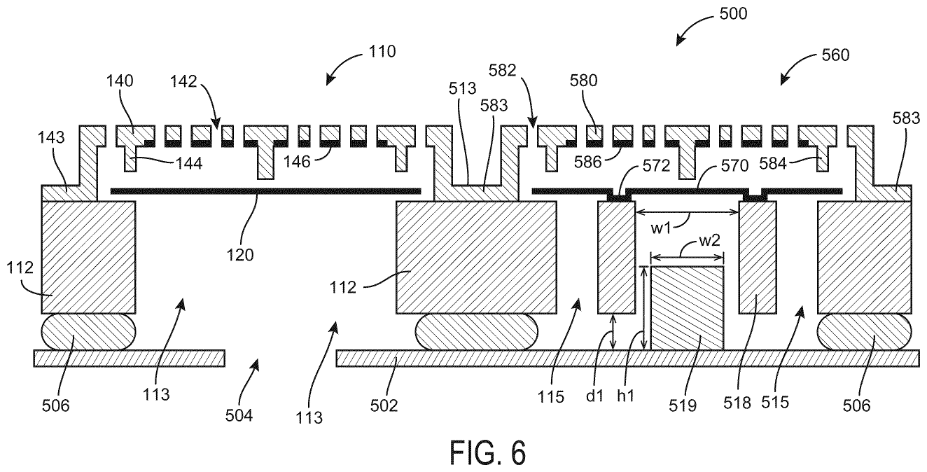

FIG. 6 is a side cross-section view of a transducer assembly 500, according to an embodiment. The transducer assembly 500 is similar to the transducer assembly 100 in many respects. However, the transducer assembly 500 includes an anchor 518 coupled to and extending from a vibration transducer diaphragm 570. The transducer assembly 500 also includes a protrusion 519 that extends from a base 502 toward the vibration transducer diaphragm 570. The protrusion 519 extends past an edge of the anchor 518 to limit movement of the anchor 518 along a longitudinal axis of the transducer assembly 500.

The transducer assembly 500 is coupled to the base 502. A bonding material 506 is used to couple the transducer substrate to the base 502. The bonding material 506 may be solder, epoxy, silicone, or another material. The transducer assembly 500 includes a sound port 504 formed through the base 502 and aligned with the first aperture 113 to allow acoustic signals to enter the acoustic transducer 110. The transducer assembly 500 includes the acoustic transducer 110, as described with respect to transducer assembly 100, and a vibration transducer 560. In some embodiments, the first aperture 113 and the sound port 504 are the same size and/or shape.

The transducer assembly 500 also comprises the vibration transducer 560 monolithically integrated with the acoustic transducer 110. The vibration transducer 560 includes a single axis accelerometer configured to sense vibrations or acceleration. The vibration transducer 560 includes a second cavity 515 defined on a first side by the base 502. The vibration transducer includes the transducer substrate 112 having the second aperture 115 defined at a second location of the transducer substrate 112 radially spaced apart from first aperture 113. The vibration transducer diaphragm 570 is disposed within the second cavity 515 and on the transducer substrate 112 over the second aperture 115 and configured to vibrate in response to acceleration or vibration. In some embodiments, the vibration transducer diaphragm 570 is formed from the same layer used to form the acoustic transducer diaphragm 520, and formed simultaneously therewith via the same fabrication operations. In other embodiments, the vibration transducer diaphragm 570 is formed from a different layer used to form the acoustic transducer diaphragm 520.

The vibration transducer diaphragm 570 includes a corrugation 572. The corrugation 572 extends toward the base 502. The corrugation 572 is a circumferential corrugation formed in the vibration transducer diaphragm 570 about the longitudinal axis of the vibration transducer 560.

A vibration transducer back plate 580 is disposed on the transducer substrate 112 axially spaced apart from the vibration transducer diaphragm 570 to define a second side of the second cavity 515. The vibration transducer back plate 580 is similar to the acoustic transducer back plate 140.

The vibration transducer 560 also includes an anchor 518 within the second aperture 115. The anchor 518 includes a first end and a second end. The first end of the anchor 518 is coupled to the corrugation 572 of the vibration transducer diaphragm 570, and the second end, opposite the first end, extends towards the base 502. In some embodiments, the anchor 518 has a height equal to a width of the transducer substrate 112. In some embodiments, the anchor 518 is a disk shaped mass. The anchor 518 forms a central aperture (e.g., a hole, a divot, a recess, a cavity, etc.), having a width of w1. The anchor 518 suspends freely from the vibration transducer diaphragm 570 into the second aperture 115 to form a suspended proof-mass. In some embodiments, the anchor 518 is coupled to the vibration transducer back plate 580.

The vibration transducer 560 also includes a protrusion 519 coupled to and extending from the base 502 towards the vibration transducer diaphragm 570 into the second aperture 115. In some embodiments, the protrusion 519 and the base 502 are formed as a monolithic structure. In other embodiments, the protrusion 519 is formed separate of the base 502 and coupled to the base 502. The protrusion can be a regular shape, for example, a square, a circle, a rectangle, a triangle, etc. The protrusion also has a width (e.g., diameter, etc.) w2 and a height h1. In some embodiments, the width w2 varies along the height h1 of the protrusion 519. In other embodiments, the width w2 is constant along the height h1 of the protrusion 519. Materials used for forming the protrusion 519 may include, for example, copper, silicon, silicon oxide, silicon nitride, silicon carbide, gold, aluminum, platinum, or another material.

The protrusion 519 is positioned along a central axis of the anchor 518, the central aperture of the anchor 518 accepting at least a portion of the protrusion 519. A distance dl that the second end of the anchor 518 is positioned away from the base 502 is less than the height h1 the protrusion 519 extends from the base 502. The width w2 of the protrusion 519 is less than the width w1 of the central aperture of the anchor 518 to allow the at least a portion of the protrusion to extend into the central aperture of the anchor 518. For example, the width w2 of the protrusion is 10-100 μm less than the width w1 of the central aperture of the anchor 518.

In other embodiments, the protrusion 519 is a ring shaped member defining a central aperture. The anchor 518 extends into the central aperture of the ring shaped member and is limited from longitudinal movement by protrusion 519.

During operation, the transducer assembly 500 may be dropped and the second end of the anchor 518 is restricted from moving longitudinally by the protrusion 519 extending into the central aperture of the anchor 518. Therefore, integrity of the vibration transducer diaphragm 570 is maintained due to an inner surface of the anchor contacting the protrusion and preventing tearing of the vibration transducer diaphragm 570.

Any of the acoustic transducers (e.g., 110, 210, 310, 410, etc.) may be included in a transducer assembly with any of the vibration transducers (e.g., 160, 260, 360, 460, 560, etc.).

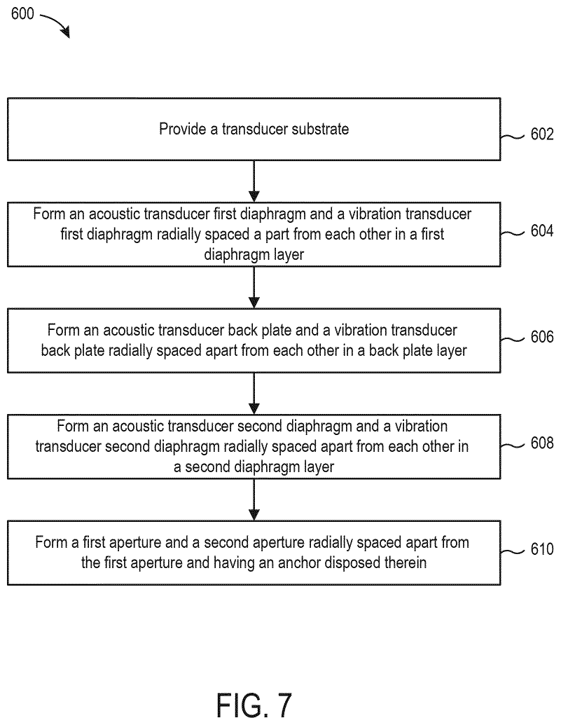

FIG. 7 is a schematic flow diagram of an example method 600 for fabricating a transducer assembly, according to an embodiment. The method 600 may be used to fabricate the transducer assembly 100, 200, 300, 400, 500, or any other transducer assembly described herein.

The method 600 includes providing a transducer substrate (e.g., the transducer substrate 112), at 602. At 604, an acoustic transducer first diaphragm (e.g., the acoustic transducer diaphragm 120, 220, 320, 420) and a vibration transducer first diaphragm (e.g., the vibration transducer diaphragm 170, 270, 370, 470, 570) is formed on the transducer substrate. The acoustic transducer first diaphragm and the vibration transducer first diaphragm are formed from the same layer and are radially spaced apart from each other. A portion of a perimetral edge of the acoustic transducer first diaphragm may be coupled to a corresponding portion of a perimetral edge of the vibration transducer first diaphragm. In some embodiments, inwards or outward facing corrugations may be formed in the acoustic transducer first diaphragm and/or the vibration transducer first diaphragm.

At 606, an acoustic transducer back plate (e.g., the acoustic transducer back plate 140, 240, 340, 440) and a vibration transducer back plate (e.g., the vibration transducer back plate 180, 280, 380, 480, 580) is formed on the transducer substrate. The acoustic transducer back plate and the vibration transducer back plate are formed from the same layer and are radially spaced apart from each other. A portion of a perimetral edge of the acoustic transducer back plate may be coupled to a corresponding portion of a perimetral edge of the vibration transducer back plate. A plurality of apertures may be defined in the acoustic transducer back plate and/or the vibration transducer back plate.

In some embodiments, the method 600 may also include forming an acoustic transducer second diaphragm (e.g., the acoustic transducer second diaphragm 430) and a vibration transducer second diaphragm (e.g., the vibration transducer second diaphragm 490) disposed above and spaced apart from the acoustic transducer first diaphragm and the vibration transducer first diaphragm, respectively, at 608. A first cavity is defined between the acoustic transducer first and second diaphragms, within which the acoustic transducer back plate is disposed, and a second cavity is defined between the vibration transducer first and second diaphragms within which the vibration transducer back plate is disposed, as previously described herein.

At 610, a first aperture (e.g., the first aperture 113) is formed in the transducer substrate below the acoustic transducer first diaphragm, and a second aperture (e.g., the second aperture 115) is formed in the transducer substrate radially spaced apart from the first aperture below the vibration transducer first diaphragm such that a substrate island is disposed in the second aperture. The substrate island is coupled to one of the vibration transducer first diaphragm or the vibration transducer back plate to form an anchor, which is suspended in the second aperture to serve as a proof-mass.

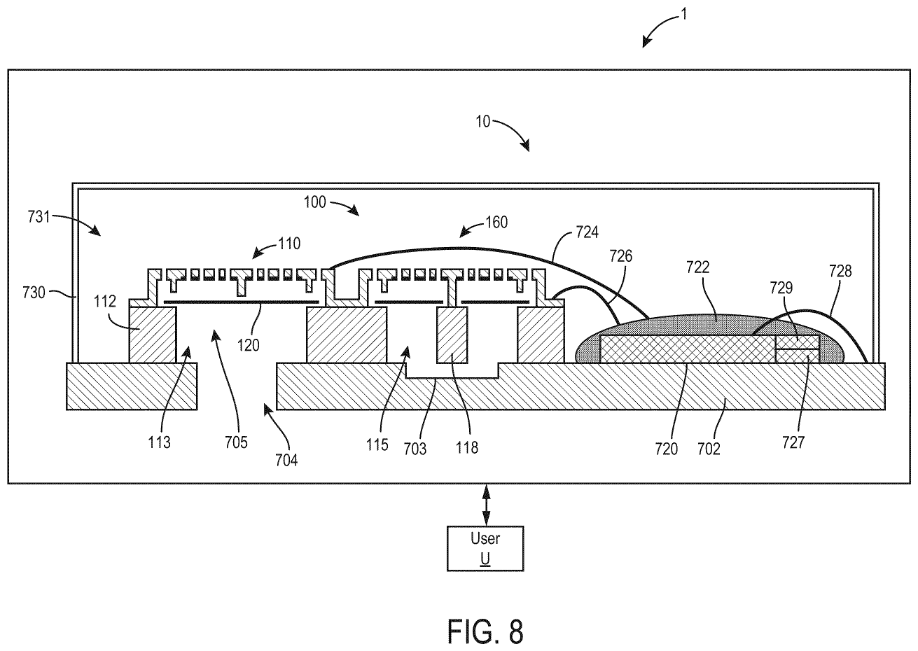

In some embodiments, the transducer assembly 100, 200, 300, 400, 500 or any other transducer assemblies described herein may be included in a microphone assembly. For example, FIG. 8 is a side cross-section view of a microphone assembly 10, according to a particular embodiment. The microphone assembly 10 is included in a wearable device 1 (e.g., a smart watch, a headphone, a smart textile, etc.) associated with a user U, and is used for converting acoustic signals into electrical signals received by the wearable device 1.

The microphone assembly 10 comprises a base 702, the transducer assembly 100 including the acoustic transducer 110 and the vibration transducer 160, an integrated circuit 720, an ADC 727, a DSP 729, and an enclosure or cover 730. The base 702 can be formed from materials used in printed circuit board (PCB) fabrication (e.g., plastics). For example, the base 702 may include a PCB configured to mount the transducer assembly 100 the integrated circuit 720, the ADC 727, the DSP 729, and the enclosure 730 thereon. A sound port 704 is formed through the base 702. The acoustic transducer 110 is positioned on the sound port 704 such that the first aperture 113 thereof is aligned with the sound port 704 to allow reception of an acoustic signal received through the sound port 704. While shown as including the transducer assembly 100, in other embodiments, the microphone assembly 10 may include the transducer assembly 200, 300, 400 or any other transducer assembly described herein. The base 702 may also include a slot 703 defined in the base 702 at second location aligned with the second aperture 115 defined in the transducer substrate 112. The slot 703 is configured to allow movement of the anchor 118 therewithin, as the anchor 118 translates in response to vibration or acceleration. In other embodiments, the anchor 118 may have a height, which is smaller than a thickness of the substrate 112, and thus the height of the second aperture 115. This allows sufficient space for the anchor 118 to translate in the second aperture 115 such that the slot 703 can be excluded. While FIG. 8 shows the microphone assembly 10 including the transducer assembly 100, in other embodiments, the microphone assembly 10 may include an acoustic transducer and a vibration transducer (e.g., an accelerometer) which are physically separate from each other.

In FIG. 8, the transducer assembly 100, the integrated circuit 720, the ADC 727 and the DSP 729 are shown disposed on a surface of the base 702, but in other embodiments one or more of these components may be disposed on the enclosure 730 (e.g., on an inner surface of the enclosure 730) or sidewalls of the enclosure 730, or stacked atop one another. In some embodiments, the base 702 includes an external-device interface having a plurality of contacts coupled to the integrated circuit 720, for example, to connection pads (e.g., bonding pads) which may be provided on the integrated circuit 720. The contacts may be embodied as pins, pads, bumps, or balls among other known or future mounting structures. The functions and number of contacts on the external-device interface depend on the protocol or protocols implemented and may include power, ground, data, and clock contacts among others. The external-device interface permits integration of the microphone assembly 10 with a host device using reflow-soldering, fusion bonding, or other assembly processes.

As shown in FIG. 8, the acoustic transducer diaphragm 120 separates a front volume 705 defined between the acoustic transducer diaphragm 120 and the sound port 704, from a back volume 731 of the microphone assembly 10 between the enclosure 730 and the diaphragm 120. The embodiment shown in FIG. 8 includes a bottom port microphone assembly 10 in which the sound port 704 is defined in the base 702 such that the internal volume 731 of the enclosure 730 defines the back volume 731. It should be appreciated that in other embodiments, the concepts described herein may be implemented in a top port microphone assembly in which a sound port is defined in the enclosure 730 of the microphone assembly 10. In some embodiments, a pierce or throughhole is defined through the diaphragm 120 to provide pressure equalization between the front and back volumes 705 and 731. In other embodiments, a vent may be defined in the enclosure 730 to allow pressure equalization.

The integrated circuit 720 is positioned on the base 702. The integrated circuit 720 is electrically coupled to the acoustic transducer 110, for example, via a first electrical lead 724, and to the vibration transducer 160 via second electrical lead 726. The integrated circuit 720 may also be coupled to the base 702 (e.g., to a trace or other electrical contact disposed on the base 702) via a third electrical lead 728. The integrated circuit 720 receives an electrical signal from the acoustic transducer 110 and the vibration transducer 160. The integrated circuit 720 is also coupled to the ADC 727 configured to convert analog signals generated by the acoustic transducer 110 into a digital signal, and the DSP 729 configured to filter and/or amplify the acoustic signals received from the acoustic transducer 110. While shown as being separate from the integrated circuit 720 in FIG. 8, in other embodiments, the ADC 727 and the DSP 729 may be integrated with the integrated circuit 720. The integrated circuit 720 may also include a protocol interface (not shown), depending on the output protocol desired. The integrated circuit 720 may also be configured to permit programming or interrogation thereof as described herein. Exemplary protocols include but are not limited to PDM, PCM, SoundWire, I2C, I2S, and SPI, among others.

A protective coating 722 may be disposed on the integrated circuit 720, in some implementations. In particular implementations, the protective coating 722 may also be disposed over the ADC 727 and the DSP 729. The protective coating 722 may include, for example a silicone gel, a laminate, or any other protective coating configured to protect the integrated circuit 720 from moisture and/or temperature changes.

The enclosure 730 is positioned on the base 702. The enclosure 730 defines the internal volume 731 within which at least the integrated circuit 720 and the transducer assembly 100 is positioned. For example, as shown in FIG. 8, the enclosure 730 is positioned on the base 702 such that the base 702 forms a base of the microphone assembly 10, and the base 702 and the enclosure 730 cooperatively define the internal volume 731. As previously described herein, the internal volume 731 defines the back volume of the microphone assembly 10. The enclosure 730 may be formed from a suitable material such as, for example, metals (e.g., aluminum, copper, stainless steel, etc.), and may be coupled to the base 702, for example, via an adhesive, soldered or fusion bonded thereto.

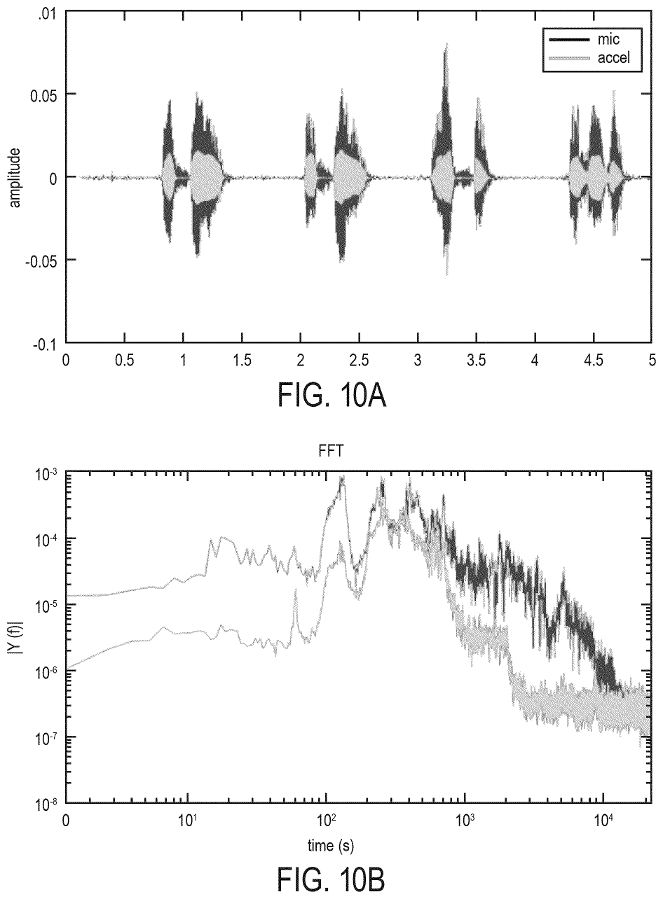

The integrated circuit 720 is configured to determine if an acoustic signal detected by the acoustic transducer 110 corresponds to the user U. The integrated circuit achieves this by correlating the acoustic signal produced by the user U due to the user U speaking, with a vibration signal detected by the vibration transducer 160 due to vibrations conducted through the body of the user U (e.g., via bone conduction) because of the user U speaking to the wearable device 1. The vibration signal includes low frequency vibrations (e.g., in a range of 50 Hz to 3 KHz) and are generated because of the vibration of the vocal cords of the user U that are also generating the acoustic signal. If the acoustic signal and the vibration signal are generated by the same source, that is the user U wearing the wearable device 1, the acoustic and vibration signals will correlate, i.e., have the same frequency and location of peaks and crests in time irrespective of the amplitude of the individual signals. For example, FIG. 10A shows a plot of an acoustic signal and a vibration signal that correlates with the acoustic signal. FIG. 10B shows FFT plots of the acoustic signal and vibration signal of FIG. 10A.

Therefore, the integrated circuit 720 uses the correlation between the vibration signal and the acoustic signal to determine whether the acoustic signal was actually generated by the user U or by another source. The integrated circuit 720 does not decode the vibration signal, but only determines if the vibration data was transmitted. Thus, an accuracy of the vibration transducer 160 may be quite low while still providing good performance.

In some embodiments, the vibration signal from the vibration transducer 160 is provided on an output pin of the integrated circuit 720 along with the acoustic signal from the acoustic transducer 110. In certain applications where significant acoustic interference is present, such as windy or noisy environments, the vibration signal from the vibration transducer 160 may be used with the acoustic signal from the acoustic transducer 110 to improve the overall quality of the signal received from the user U speaking.

In some embodiments, the integrated circuit may also be configured to activate the ADC 727 and the DSP 729 only when a correlation is detected between the acoustic signal and the vibration signal. For example, the ADC 727, the DSP 729 and/or other electronic components of the wearable device 1 may normally be inactive (e.g., turned OFF) to conserve power. The integrated circuit 720 may activate the ADC 727 and the DSP 729 when an acoustic signal is received by the transducer assembly 100, which corresponds to a vibration signal received by the transducer assembly 100, which confirms that the acoustic signal was produced by the authorized user U. This prevents false activation of the ADC 727 and DSP 729 due to acoustic signals, which do not correspond to the user U, saves power and increases battery life.

In other embodiments, the integrated circuit 720 may be configured to activate components or features of the wearable device 1 in response to detecting specific vibration patterns that can be detected by the vibration transducer 160. For example, the wearable device 1 may include a head phone or ear bud, and the user U may touch their face or head to generate specific vibration patterns for activating features of the wearable device 1, for example, places calls, receive calls, increase or decrease volume, play, stop or start a sound track, etc.

In still other embodiments, the integrated circuit 720 may be configured to sequentially activate the ADC 727 when a vibration or acceleration is detected (e.g., due to the user U performing a specified gesture which produces a specified vibration pattern detected by the vibration transducer 160), and then activate the DSP 729 when an acoustic signal is detected.

FIG. 9 is a schematic block diagram of the integrated circuit 720, according to a particular embodiment. The integrated circuit 720 may include one or more components, for example, a processor 721, a memory 723, and/or a communication interface 725. The processor 121 may be implemented as one or more general-purpose processors, an application specific integrated circuit (ASIC), one or more field programmable gate arrays (FPGAs), a group of processing components, or other suitable electronic processing components. In some implementations, the DSP 729 and/or the ADC 727 be stacked on the integrated circuit 720. In some embodiments, the one or more processors 721 may be shared by multiple circuits and may execute instructions stored, or otherwise accessed, via different areas of memory. Alternatively, or additionally, the one or more processors 721 may be structured to perform or otherwise execute certain operations independent of one or more co-processors. In other example embodiments, two or more processors 721 may be coupled via a bus to enable independent, parallel, pipelined, or multi-threaded instruction execution. All such variations are intended to fall within the scope of the present disclosure. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

In some embodiments, the integrated circuit 720 may include a memory 723. The memory (e.g., RAM, ROM, Flash Memory, hard disk storage, etc.) may store data and/or computer code which may be executable by the processor 721 included in the integrated circuit 720. The memory 723 may be or include tangible, non-transient volatile memory or non-volatile memory. Accordingly, the memory 723 may include database components, object code components, script components, or any other type of information structure for supporting the various activities and information structures of the microphone assembly 10. In various embodiments, the integrated circuit 720 and/or the DSP 729 may include one or more signal amplification circuitry (e.g., transistors, resistors, capacitors, operational amplifiers, etc.) or noise reduction circuitry (e.g., low pass filters, high pass filters, band pass filters, etc.) The communication interface 725 may include wired and/or wireless interfaces (e.g., jacks, antennas, transmitters, receivers, communication interfaces, wire terminals, etc.) for conducting data communications with the transducer assembly 100 and external devices (e.g., a central controller of a wearable device 1 including the microphone assembly 10).

The integrated circuit 720 may include an acoustic signal determination circuitry 723a, a vibration signal determination circuitry 723b, a signal correlation circuitry 723c, and an activation circuitry 723d. The various circuitries may be embedded as hardware configured to communicate with the one or more processors 721, algorithms or instructions stored in the memory 723 that are executable by the one or more processors 721, or a combination thereof.

The acoustic signal determination circuitry 723a is configured to receive the acoustic signal from the acoustic transducer 110. The vibration signal determination circuitry 723b is configured to receive the vibration signal from the vibration transducer 160. The signal correlation circuitry 723c is configured to correlate the vibration signal with the acoustic signal to determine if a correlation exists between the acoustic signal and the vibration signal. The activation circuitry 723d is configured to selectively activate components of the microphone assembly 10 (e.g., the ADC 727 or the DSP 729) in response to the vibration signal correlating to the acoustic signal.

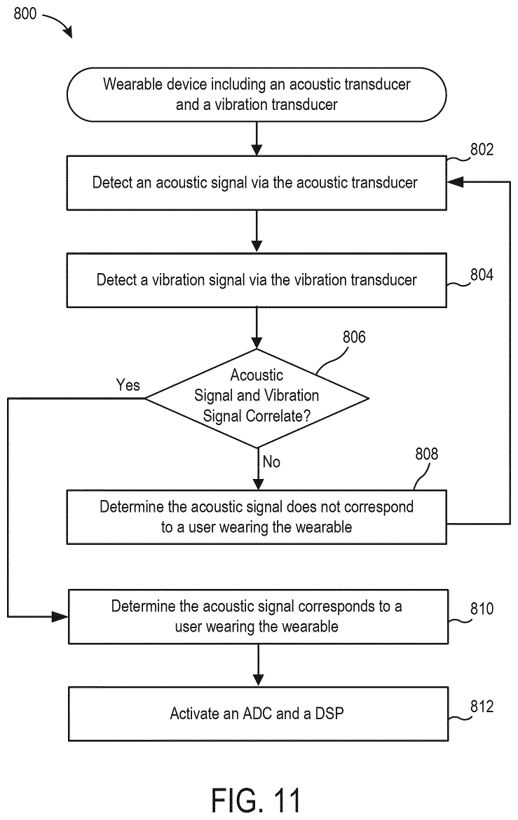

FIG. 11 is a schematic flow diagram of a method 800 for determining that an acoustic signal corresponds to an authorized user wearing a wearable device (e.g., the wearable device 1) that includes a transducer assembly (e.g., the transducer assembly 100, 20, 300, 400, 500) including an acoustic transducer (e.g., the acoustic transducer 110, 210, 310, 410) and a vibration transducer (e.g., the vibration transducer 160, 260, 360, 460, 560), according to an embodiment. The operations of the method 800 may be implemented in wearable devices that include a microphone assembly including an integrated transducer assembly, or including an acoustic transducer and accelerometer (e.g., a single or dual axis accelerometer) that are separate from each other.

The method 800 includes detecting an acoustic signal via the acoustic transducer, at 802. For example, the acoustic signal determination circuitry 723a receives the acoustic signal detected by the acoustic transducer 110. At 804, a vibration signal is detected via the vibration transducer. For example, the vibration signal determination circuitry 723b receives the vibration signal detected by the vibration transducer 160. At 806, the method 800 includes determining whether a correlation exists between the acoustic signal and the vibration signal. For example, the signal correlation circuitry 723c determines a correlation between the vibration signal and the acoustic signal. If the vibration signal does not correlate to the acoustic signal (806: NO), a determination is made that acoustic signal does not correspond to the user wearing the wearable device, and the method returns to operation 802.

In response to the vibration signal correlating to the acoustic signal (806: YES), a determination is made that the acoustic signal corresponds to the user wearing the wearable device, at 810. In some embodiments, the method 800 may also include activating an ADC (e.g., the ADC 727) and a DSP (e.g., the DSP 729) associated with a microphone assembly (e.g., the microphone assembly), at 812, if the acoustic signal corresponds to the user wearing the wearable device. In some embodiments, one or more features of the wearable device (e.g., the wearable device 1) are also activated once a correlation is determined between the vibration signal and the acoustic signal.

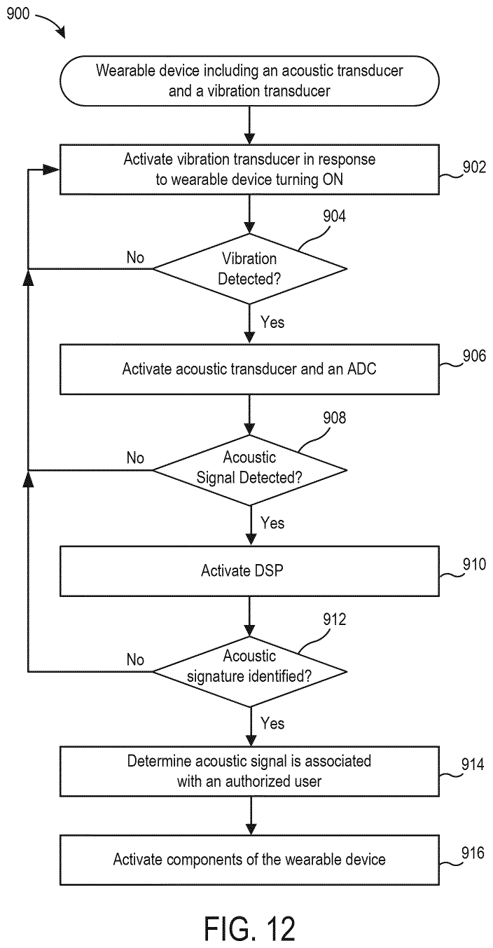

FIG. 12 is a schematic flow diagram of a method 900 for selectively activating portions of a wearable device (e.g., the wearable device 1) that includes a microphone assembly (e.g., the microphone assembly 10) including an acoustic transducer and a vibration transducer, responsive to vibration signals and acoustic signals, according to an embodiment. The operations of the method 900 may be implemented in wearable devices that include a microphone assembly including an integrated transducer assembly (e.g., the transducer assembly 100, 200, 300, 400), or an acoustic transducer and accelerometer (e.g., a single or dual axis accelerometer) that are separate from each other.

The method 900 includes activating the vibration transducer in response to wearable device being turned ON, at 902. The wearable device may enter sensing mode when the wearable device is turned ON. At 904, the method 900 includes determining if a vibration is detected. For example, the vibration signal determination circuitry 723b may determine if a vibration signal is detected by the vibration transducer. In response to a vibration signal being detected (904: YES), the method 900 includes activating an acoustic transducer and an ADC (e.g., the ADC 727) of the microphone assembly (e.g., the microphone assembly 10).

At 908, the method 900 includes determining if an acoustic signal is detected by the acoustic transducer. If an acoustic signal is not detected (908: NO), the method 900 returns to operation 902. In response to an acoustic signal being detected (908: YES), the method 900 includes activating a DSP (e.g., the DSP 729) of the microphone assembly or the wearable device, at 910.

At 912, the method 900 includes determining if an acoustic signature is identified from the acoustic signal. For example, the acoustic signature may include a key word or key phrase corresponding to a user associated with the wearable device. If the key word or key phrase is not associated with the user (912: NO), the methods 900 returns to operation 902. In response to the key word or key phrase being associated with the user (912: YES), the method 900 includes determining that the acoustic signal is associated with an authorized user, at 914. At 916, various components of the wearable device are activated.

Some implementations relate to a transducer assembly including an acoustic transducer. The acoustic transducer includes a transducer substrate having a first aperture defined at a first location of the transducer substrate, an acoustic transducer diaphragm disposed on the transducer substrate over the first aperture, and an acoustic transducer back plate disposed on the transducer substrate axially spaced apart from the acoustic transducer diaphragm over the first aperture. The transducer assembly also includes a vibration transducer. The vibration transducer includes the transducer substrate having a second aperture defined at a second location thereof, a vibration transducer diaphragm disposed on the transducer substrate over the second aperture, a vibration transducer back plate disposed on the transducer substrate axially spaced apart from the vibration transducer diaphragm over the second aperture, and an anchor coupled to one of the vibration transducer diaphragm or the vibration transducer back plate, the anchor disposed in the second aperture and suspended freely therewithin.

Some implementations relate to a transducer assembly that includes a base defining a base aperture, a protrusion extending from a first side of the base, and an acoustic transducer coupled to the first side of the base. The acoustic transducer includes a transducer substrate, a first aperture defined at a first location of the transducer substrate, and an acoustic transducer diaphragm disposed on the transducer substrate over the first aperture. The acoustic transducer diaphragm vibrates in response to an acoustic signal. The acoustic transducer also includes an acoustic transducer back plate disposed on the transducer substrate axially spaced apart from the acoustic transducer diaphragm over the first aperture. The transducer assembly also includes a vibration transducer coupled to the first side of the base. The vibration transducer includes the transducer substrate, a second aperture defined at a second location of the transducer substrate radially spaced apart from the first aperture, and a vibration transducer diaphragm disposed on the transducer substrate over the second aperture. The vibration transducer diaphragm vibrates in response to acceleration or vibration. The vibration transducer also includes a vibration transducer back plate disposed on the transducer substrate axially spaced apart from the vibration transducer diaphragm over the second aperture, and an anchor coupled to one of the vibration transducer diaphragm or the vibration transducer back plate. The anchor is disposed in the second aperture and suspended freely therewithin.

Some implementations relate to a microphone assembly. The microphone assembly includes a base, and an acoustic transducer coupled to the base. The acoustic transducer includes a transducer substrate, a first aperture defined at a first location of the transducer substrate, and an acoustic transducer diaphragm disposed on the transducer substrate over the first aperture. The acoustic transducer diaphragm vibrates in response to an acoustic signal. The acoustic transducer also includes an acoustic transducer back plate disposed on the transducer substrate axially spaced apart from the acoustic transducer diaphragm over the first aperture. The microphone assembly also includes a vibration transducer coupled to the base. The vibration transducer includes the transducer substrate, a second aperture defined at a second location of the transducer substrate radially spaced apart from the first aperture, and a vibration transducer diaphragm disposed on the transducer substrate over the second aperture. The vibration transducer diaphragm vibrates in response to acceleration or vibration. The vibration transducer also includes a vibration transducer back plate disposed on the transducer substrate axially spaced apart from the vibration transducer diaphragm over the second aperture, and an anchor defining a first end coupled to one of the vibration transducer diaphragm or the vibration transducer back plate and a second end extending towards the base. The anchor is disposed in the second aperture and suspended freely therewithin. The microphone assembly further includes an integrated circuit. The integrated circuit receives a vibration signal from the vibration transducer and the acoustic signal from the acoustic transducer and generates an output responsive to the vibration signal and the acoustic signal.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

As used herein, the terms “approximately” generally mean plus or minus 10% of the stated value. For example, about 0.5 would include 0.45 and 0.55, about 10 would include 9 to 11, about 1000 would include 900 to 1100.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A transducer assembly, comprising:
an acoustic transducer, comprising:
a transducer substrate, a first aperture defined at a first location of the transducer substrate;
an acoustic transducer diaphragm disposed on the transducer substrate over the first aperture and configured to vibrate in response to an acoustic signal; and
an acoustic transducer back plate disposed on the transducer substrate axially spaced apart from the acoustic transducer diaphragm over the first aperture; and
a vibration transducer, comprising:
the transducer substrate, a second aperture defined at a second location of the transducer substrate spaced apart from the first aperture;
a vibration transducer diaphragm disposed on the transducer substrate over the second aperture;
a vibration transducer back plate disposed on the transducer substrate axially spaced apart from the vibration transducer diaphragm over the second aperture; and
an anchor coupled to one of the vibration transducer diaphragm or the vibration transducer back plate, the anchor disposed in the second aperture and suspended freely therewithin.

2. The transducer assembly of claim 1, wherein the acoustic transducer back plate is coupled to the transducer substrate via a support structure circumferentially positioned around the first aperture.

3. The transducer assembly of claim 1, wherein the anchor extends through a third aperture defined within one of the vibration transducer diaphragm or the vibration transducer back plate.

4. The transducer assembly of claim 1, further comprising at least one of an inward facing corrugation or an outward facing corrugation on at least one of the vibration transducer diaphragm, the vibration transducer back plate, the acoustic transducer diaphragm, or the acoustic transducer back plate.

5. The transducer assembly of claim 1, further comprising at least one of a second acoustic transducer diaphragm or a second vibration transducer diaphragm.

6. The transducer assembly of claim 5, wherein the acoustic transducer back plate is disposed between the acoustic transducer diaphragm and the second acoustic transducer diaphragm, the vibration transducer back plate is disposed between the vibration transducer diaphragm and the second vibration transducer diaphragm, and the anchor is coupled to the vibration transducer diaphragm or the second vibration transducer diaphragm.

7. The transducer assembly of claim 1, further comprising a protrusion extending from a base into the second aperture.

8. A transducer assembly, comprising:
a base defining a base aperture;
a protrusion extending from a first side of the base;
an acoustic transducer coupled to the first side of the base, the acoustic transducer comprising:
a transducer substrate, a first aperture defined at a first location of the transducer substrate;
an acoustic transducer diaphragm disposed on the transducer substrate over the first aperture and configured to vibrate in response to an acoustic signal; and
an acoustic transducer back plate disposed on the transducer substrate axially spaced apart from the acoustic transducer diaphragm over the first aperture; and
a vibration transducer coupled to the first side of the base, the vibration transducer comprising:
the transducer substrate, a second aperture defined at a second location of the transducer substrate radially spaced apart from the first aperture;
a vibration transducer diaphragm disposed on the transducer substrate over the second aperture;
a vibration transducer back plate disposed on the transducer substrate axially spaced apart from the vibration transducer diaphragm over the second aperture; and
an anchor coupled to one of the vibration transducer diaphragm or the vibration transducer back plate, the anchor disposed in the second aperture and suspended freely therewithin.

9. The transducer assembly of claim 8, wherein the vibration transducer diaphragm includes a corrugation extending away from the vibration transducer back plate.

10. The transducer assembly of claim 9, wherein the anchor has a first end and a second end opposite each other and the first end is coupled to the corrugation.

11. The transducer assembly of claim 10, wherein the anchor comprises a central aperture.

12. The transducer assembly of claim 11, wherein at least a portion of the protrusion extends past the second end and into the central aperture of the anchor.

13. The transducer assembly of claim 12, wherein the protrusion is configured to limit movement of the second end of the anchor relative to the first end of the anchor.

14. The transducer assembly of claim 8, further comprising a plurality of protrusions extending inwardly from at least one of the acoustic transducer back plate or the vibration transducer back plate.

15. A microphone assembly comprising:
a base;
an acoustic transducer coupled to the base, the acoustic transducer comprising:
a transducer substrate, a first aperture defined at a first location of the transducer substrate;
an acoustic transducer diaphragm disposed on the transducer substrate over the first aperture and configured to vibrate in response to an acoustic signal; and
an acoustic transducer back plate disposed on the transducer substrate axially spaced apart from the acoustic transducer diaphragm over the first aperture; and
a vibration transducer coupled to the base, the vibration transducer comprising:
the transducer substrate, a second aperture defined at a second location of the transducer substrate radially spaced apart from the first aperture;
a vibration transducer diaphragm disposed on the transducer substrate over the second aperture;
a vibration transducer back plate disposed on the transducer substrate axially spaced apart from the vibration transducer diaphragm over the second aperture; and
an anchor defining a first end coupled to one of the vibration transducer diaphragm or the vibration transducer back plate, and a second end extending towards the base, the anchor disposed in the second aperture and suspended freely therewithin;
an integrated circuit configured to receive a vibration signal from the vibration transducer and the acoustic signal from the acoustic transducer and generate an output responsive to the vibration signal and the acoustic signal.

16. The microphone assembly of claim 15, wherein the anchor extends through a third aperture defined within one of the vibration transducer diaphragm or the vibration transducer back plate.

17. The microphone assembly of claim 15, further comprising at least one of a second acoustic transducer diaphragm or a second vibration transducer diaphragm.

18. The microphone assembly of claim 17, wherein the acoustic transducer back plate is disposed between the acoustic transducer diaphragm and the second acoustic transducer diaphragm, the vibration transducer back plate is disposed between the vibration transducer diaphragm and the second vibration transducer diaphragm, and the anchor is coupled to the vibration transducer diaphragm or the second vibration transducer diaphragm.

19. The microphone assembly of claim 15, wherein the anchor defines a central aperture.

20. The microphone assembly of claim 19, further comprising a protrusion extending from the base, wherein the protrusion extends past the second end and into the central aperture of the anchor and is configured to limit movement of the second end relative to the first end of the anchor.
